(19) United States
(12) Patent Application Publication
(10) Pub. No.: US 2009/0011081 A1
(43) Pub. Date: Jan. 8, 2009

(54) PROCESS FOR PRODUCING NATTO YOGURT

(75) Inventors: Hsiu-Hsia Lin, Sanchong (TW); Chia-Chen Pai, Sanchong (TW)

Correspondence Address: OCCHIUTI ROHLICEK & TSAO, LLP, 10 FAWCETT STREET, CAMBRIDGE, MA, 02138, US

(73) Assignee: BRIGHT BIOTECH INTERNATIONAL CO., LTD., Taipei (TW)

(21) Appl. No.: 12/138,064

(22) Filed: Jun. 12, 2008

(30) Foreign Application Priority Data
Jun. 15, 2007 (TW) 096121635

(51) Int. Cl. A23C 9/12

(52) U.S. Cl. 426/43; 426/46; 426/583

(57) ABSTRACT

The present invention provides a process for producing a yogurt, comprising: (1) providing a protein liquid selected from the group consisting of milk, reconstituted milk and soymilk; (2) adding to the protein liquid a Bacillus subtilis var: natto strain in the number ranging from 8.33×10⁵ CFU to 2×10⁹ CFU per ml of the protein liquid; (3) incubating the protein liquid added with the Bacillus subtilis var: natto strain as obtained in step (2) at a temperature between 25° C. and 60° C. for 2 hours to 24 hours; and (4) acquiring the yogurt. The yogurt made by the process is also provided.

### CROSS-RELATED APPLICATION PARAGRAPH

This application claims the benefit of Taiwanese Application No. 096121635, filed on Jun. 15, 2007. The contents of which is hereby incorporated by reference in its entirety.

### TECHNOLOGY FIELD OF THE INVENTION

The present invention is related to a process for producing a yogurt with a Bacillus subtilis var. natto strain.

### BACKGROUND OF THE INVENTION

Yogurt is a fermented dairy product made by adding bacterial cultures to milk, which causes the transformation of the milk's sugar, lactose, into lactic acid. Through this process, the yogurt as made has a refreshingly tart flavor and a unique pudding-like texture, a quality that is reflected in its original Turkish name, Yoghurmak, which means “to thicken”. Today, yogurt plays an important role in the world, particularly Turkey, Greece, India, as well as in Middle East, Eastern Europe and Asia, such as in Turkey, Greece, and India.

There are various types of yogurt:

(1) Set yogurt: A solid set where the yogurt firms in a container without disturbance;

(2) Stirred yogurt: Yogurt made in a large container then spooned or otherwise dispensed into secondary serving containers wherein the consistency of the “set” is broken and the texture is less firm than set yogurt which is the most popular form of commercial yogurt; and

(3) Drinking yogurt: Stirred yogurt to which additional milk and flavors are mixed in. One can add fruit or fruit syrups to enhance the flavor, the shelf life of which product is 4-10 days, since the pH is raised by fresh milk addition, and some whey separation will occur and is natural.

Yogurt has nutritional benefits beyond those of milk: people who are lactose-intolerant can enjoy yoghurt without ill effects, because the lactose in the milk precursor is converted to lactic acid by the bacterial culture. Moreover, in some researches it has been found that yogurt containing live bacterial cultures may fortify the immune system. Researchers presume that lactic acid-producing bacteria traditionally used to make yogurt—Lactobacillus bulgaricus and Streptococcus thermophilus—confer on yogurt many of its health benefits.

Although yogurts become popular food products in the market, there are still some defects that are necessary to be solved. First, after a subject takes a yogurt, most lactic acid bacteria in the yogurt will be lost when contacting stomach acid and bile in the subject, and thus lowering their effects of inhibiting the proliferation of pathogens in the intestine. Second, yogurt generally has a 10-21 day shelf life when it is made and stored properly in the refrigerator below 40° F. Molds, yeasts and slow growing bacteria can spoil the yogurt during prolonged storage. However, according to the traditional process for a yogurt, additives to be added to the yogurt should be clean and of a good quality, which is hard to be controlled for homemade yogurts. Last, because the traditional yogurts made from lactic acid-producing bacteria taste sour and accordingly flavoring or sweetening agents are often added in commercial yogurts, such as cane sugars or fructose, most of which are harm to health.

Given the above, there is still a need of a new process for producing a yogurt that is good for health and meets the market demands.

### BRIEF SUMMARY OF THE INVENTION

The present invention features a process for making a fermented drink with a Bacillus subtilis var. natto strain other than the commonly used bacterial strains such as Lactobacillus bulgaricus and Streptococcus thermophilus.

In one aspect, the present invention provides a process for producing a yogurt, comprising: (1) providing a protein liquid selected from the group consisting of milk, reconstituted milk and soymilk; (2) adding to the protein liquid a Bacillus subtilis var. natto strain in the number ranging from 8.33×10⁵ CFU to 2×10⁹ CFU per ml of the protein liquid; (3) incubating the protein liquid added with the Bacillus subtilis var. natto strain as obtained in step (2) at a temperature between 25° C. and 60° C. for 2 hours to 24 hours; and (4) acquiring the yogurt.

In another aspect, the present invention provides a yogurt produced by the process of the present invention.

### DETAILED DESCRIPTION OF THE INVENTION

As used herein the following terms may be used for better interpretation of the claims and specification.

The present invention provides a process for producing a yogurt, comprising: (1) providing a protein liquid selected from the group consisting of milk, reconstituted milk and soymilk; (2) adding to the protein liquid a Bacillus subtilis var: natto strain in the number ranging from 8.33×10⁵ CFU to 2×10⁹ CFU per ml of the protein liquid; (3) incubating the protein liquid added with the Bacillus subtilis var: natto strain as obtained in step (2) at a temperature between 25° C. and 60° C. for 2 hours to 24 hours; and (4) acquiring the yogurt.

As used herein, the term “yogurt” refers to a product produced by a bacterial fermentation of a protein liquid, particularly milk. According to the traditional fermentation of milk with a lactic acid-producing bacterium for preparation of a yogurt, lactose (milk sugar) will produce lactic acid during the fermentation, which acts on milk protein to provide a good texture and characteristic tang. In one embodiment of the invention, edible milk generally comes from cows, but occasionally from other mammals such as goats, sheep, water buffalo, yaks, or horses, may be used for producing the yogurt. Alternatively, soymilk also can be used to make soy yogurt in one embodiment.

As used herein, the term “protein liquid” refers to a liquid containing a substantial amount of proteins. Generally, the protein liquid used in the invention is an opaque white liquid produced by the mammary glands of female mammals. However, the protein liquid also refers to soymilk. Soybean contains abundant proteins, about 40% by weight, and soymilk contains about the same proportion of protein as cow's milk, around 3.5% protein; as well as 2% fat, 2.9% carbohydrate and 0.5% ash. Soymilk can be made at home with traditional kitchen tools or with a soy milk machine.

The term “CFU (colony forming unit)” used herein refers to a measure of viable bacterial numbers by counting the colony numbers. The theory of CFU establishes that a single bacterium can grow and become a colony, via binary fission. These colonies are clearly different between each other, both microscopically and macroscopically. By convenience, the results are given as CFU/ml. Therefore, it allows knowing what are the microbiological load and the magnitude of the infection in humans and animals, or the degree of contamination in samples of water, vegetables, soil or fruits and in industrial products and the equipment.

As used herein, the term “a Bacillus subtilis var: natto strain” refers to a strain of Bacillus subtilis var: natto, which is a Gram-positive, catalase-positive bacterium commonly found in soil. The B. subtilis var: natto strain is not considered a human pathogen, which may contaminate food but rarely causes food poisoning. Therefore, the B. subtilis var: natto strain is classified as GRAS (generally recognized as safe), which is a United States of America Food and Drug Administration (FDA) designation that a chemical or substance added to food is considered safe by experts.

As compared to the traditionally used lactic acid-producing bacteria, the Bacillus subtilis var: natto strain has several advantages, including (1) the B. subtilis var: natto strain can divide asymmetrically, and produce an endospore that is resistant to environmental factors such as heat, acid, and salt, and can persist in the environment for long periods of time so that the B. subtilis var. natto strain can successfully resist stomach acid and bile and preserve its effect in the intestines; (2) the B. subtilis var. natto strain is capable of suppressing the proliferation of certain E. coli, thus favorably adjusting the condition in the intestines; (3) the B. subtilis var. natto strain can grow at various temperatures, including a room temperature (25° C.), with a low risk of contamination by other bacteria, thus making it more convenient to make yogurt at home; (4) the B. subtilis var. natto strain can generate a hygienic compound, Nattokinase, which is a novel fibrinolytic enzyme that is considered to be potential in thrombosis therapy so that the yogurt made by the B. subtilis var. natto strain according to the present invention provides an efficacy in preventing from cardiovascular diseases. In one embodiment of the invention, the B. subtilis var. natto strain as used is in the form of dry powder, preferably the dry powder of the Bacillus subtilis var. natto strain contains at least 1×10⁹ CFU/g of the bacteria.

The conditions for producing the yogurt prepared by the process of the present invention depend on the natures of the protein liquid as used. In one embodiment of the invention wherein low fat milk is used as the protein liquid, the number of the B. subtilis var. natto strain as used ranges from 8.33×10⁵ CFU/ml to 6.67×10⁶ CFU/ml, and the milk with the B. subtilis var. natto strain is incubated in a temperature between 25° C. and 60° C. for 2 hours to 8 hours. Most preferably, the number of the Bacillus subtilis var. natto strain as used is 6.67×10⁶ CFU/ml, and the milk with the B. subtilis var. natto strain is incubated at 25° C. for 8 hours.

In one embodiment of the invention, the protein liquid is reconstituted low fat milk. For instance, in the process of the invention using the reconstituted low fat milk containing 0.013 g/ml to 0.054 g/ml of milk protein, preferably 0.04 g/ml, the number of the B. subtilis var. natto strain as used ranges from 8.33×10⁵ CFU/ml to 6.67×10⁶ CFU/ml, and the reconstituted low fat milk with the B. subtilis var. natto strain is incubated preferably in a temperature between 25° C. and 37° C. for 2 hours to 24 hours. Most preferably, the number of the Bacillus subtilis var. natto strain as used is 6.67×10⁶ CFU/ml, and the milk with the Bacillus subtilis var. natto strain is incubated at 37° C. for 3 hours.

In another embodiment of the invention, the protein liquid is soymilk. In the process of the invention using the soymilk being sugarless, the number of the Bacillus subtilis var. natto strain as used ranges from 5×10⁸ CFU/ml to 2×10⁹ CFU/ml, and the sugarless soymilk with the Bacillus subtilis var. natto strain is incubated at 37° C. for 7 hours to 9 hours.

The present invention provides a yogurt produced by the process as mentioned above. If desired, the yogurt may then be blended with additional spices or other additives. In addition, a variety of additives can be included either before, after or while the milk is being cultured. Examples of additives include but are not limited to colorings (e.g., beta-carotene, anatto, tumeric, paprika and FD & C dyes); flavors, aromas, sweeteners; emulsifiers and/or thickening agents; preservatives, vitamins and antioxidants (e.g., vitamins A, C, D, E, B-1, B-5, B-6, zinc, selenium, calcium, alpha-tocopherol, glutathione, butylated hydroxytoluene (BHT), butylated hydroxyanisole (BHA), and cysteine).

The present invention also provides a dietary or pharmaceutical composition comprising the yogurt produced according to the invention alone or in conjunction with an edible carrier, or a pharmaceutically acceptable carrier. As used herein the phrase “an dible carrier” refers to a substance that is fit to be eaten, such as food or drink. As used herein, the phrase “a pharmaceutically acceptable carrier” refers to a substance that can be co-administered with a yogurt and performs its intended function. Examples of such carriers include but are not limited to solutions, solvents, dispersion media, delay agents, emulsions and any conventional carriers commonly used in the art.

Without further elaboration, it is believed that one skilled in the art can, based on the above description, utilize the present invention to its fullest extent. The following specific embodiments are, therefore, to be construed as merely illustrative, and not limitative of the remainder of the disclosure in any way whatsoever. All publications cited herein are incorporated by reference.

### EXAMPLE 1

### Preparation of a Yogurt Using a Bacillus Subtilis Var. Natto Strain

The dry powder of a B. subtilis var. natto strain was isolated and obtained from nattos. Low fat milk at the volume of 150 ml was added with 1 g of the dry powder of the B. subtilis var. natto strain at the number of 1×10⁹ CFU/g, to obtain a final mixture containing 6.67×10⁶ CFU/ml of the bacterial strain. The mixture was incubated at 37° C. to obtain a green whey or milk plasma after the fermentation. The curd and the production of the whey were observed, and the results were recorded at various times. According to the observations, it was found that the incubation for 6 hours was preferred for producing a yogurt in the likeness of the traditional and commercial yogurts fermented by lactic acid-producing bacteria. However, the yogurt according to the invention tasted bitter, but not so sour as the traditional yogurts made with lactic acid-producing bacteria.

### EXAMPLE 2

### Experiments for Determination of the Optimal Number of the B. subtilis var: natto Strain and Incubation Temperature

Into 4 appropriate containers each containing 150 ml low fat milk, 0.125 g, 0.25 g, 0.5 g and 1 g of the dry powder of the B. subtilis var: natto strain were added, respectively to obtain the final numbers of the bacteria in the containers being 8.33×10⁵ CFU/ml, 1.67×10⁶ CFU/ml, 3.33×10⁶ CFU/ml and 6.67×10⁶ CFU/ml, respectively. To determine the optimal temperature, 4 containers were prepared as above for each of the incubations at 25° C. (room temperature), 37° C., 45° C. and 60° C., and the time when whey occurred were recorded and shown in Table I.

According to Table I, the higher the temperature was, the faster the whey occurred. A tasty yogurt that was good for health and met the market demands was obtained by a process wherein 150 ml of the low fat milk with 1 g of the dry powder of the bacterial strain was incubated at 25° C. for 8 hours. The yogurt as obtained was sourish, but not so sour as the traditional yogurts made with lactic acid-producing bacteria. Therefore, any additive was not required to suppress the sour for the yogurt according to the invention.

TABLE I
The times required for obtaining natto yogurts at different temperatures

| | 0.125 g | 0.25 g | 0.5 g | 1 g |
|---|---|---|---|---|
| | (8.33 × 10⁵ | (1.67 × 10⁶ | (3.33 × 10⁶ | (6.67 × 10⁶ |
| | CFU/ml) | CFU/ml) | CFU/ml) | CFU/ml) |
| 25° C. | 22 hr | 20 hr | 16 hr | 8 hr |
| 37° C. | 18 hr | 16 hr | 8 hr | 6 hr |
| 45° C. | 8 hr | 6.5 hr | 5 hr | 4 hr |
| 60° C. | — | 5 hr | 3.5 hr | 2 hr |

— means that no whey occurred at 60° C. when 0.125 g dry powder was added.

### EXAMPLE 3

### Preparation of a Natto Yogurt from Reconstituted Low Fat Milk

In consideration that most commercial yogurts were made from reconstituted low fat milk, reconstituted low fat milk was used in the example to make a natto yogurt, and the optimal density of the milk protein in the low fat milk was determined.

The reconstituted milk solutions were prepared by mixing commercial low fat milk powder of 6 g (having milk protein of 0.013 g/ml), 12 g (milk protein of 0.026 g/ml), 15 g (milk protein of 0.033 g/ml), 18 g (milk protein of 0.040 g/ml), 21 g (milk protein of 0.046 g/ml) and 24 g (milk protein of 0.054 g/ml), respectively, with warm water till the final volume of each was 150 ml. The concentration of the milk protein for each of the six test group was calculated based on the information provided with the commercial low fat milk products (wherein the milk protein was contained at the amount of 33.4 g per 100 g of the milk powder). To each of the solutions of the milk powder prepared as above, 1 g (1×10⁹ CFU) of the dry powder of the B. subtilis var. natto strain was added into the solutions of the reconstituted milk and the mixture was stirred. The mixtures of the six groups were incubated at 37° C., and the time when whey occurred was recorded and summarized in the following Table II.

TABLE II
The time required for producing natto yogurts from reconstituted low
fat milk

| | Milk protein (g/ml) | | | | | |
|---|---|---|---|---|---|---|
| | 0.013 | 0.026 | 0.033 | 0.040 | 0.0460 | 0.054 |
| Time (hr) | 24 | 7 | 4 | 3 | 2 | 2 |

According to Table II, it was found that the solution having a higher concentration of the milk protein curdled in a shorter period of time. As compared with the yogurt made by fresh milk, the yogurt made from low fat milk was softer. Both of the yogurts as made tasted bitter. It was also found that the yogurt made from 18 g of the milk powder had an appearance and texture like the yogurt made from fresh milk.

### EXAMPLE 4

### Preparation of Natto Yogurts from Soymilk

The soymilk made from soybean was used for preparation the natto yogurt of the invention. For each group, 2 g (2×10⁹ CFU), 1 g (1×10⁹ CFU) or 0.5 g (5×10⁸ CFU) of the dry powder of the B. subtilis var. natto strain was added into 150 ml of sugarless soymilk. After stirring, the mixtures were incubated at 37° C., and the times when the soymilk was clotting were recorded and summarized in the following Table III. Since no whey occurred in the yogurts made from soymilk, the incubation times were determined by the status of curd.

TABLE III
The time required for producing natto yogurts from 150 ml of soymilk

| | Dry powder of | | |
|---|---|---|---|
| | B. subtilis var. natto | | |
| | 0.5 g | 1 g | 2 g |
| | (5 × 10⁸ CFU) | (1 × 10⁹ CFU) | (2 × 10⁹ CFU) |
| Time (hr) | 9 | 8 | 7 |

According to Table III, the yogurts could be obtained within 9 hours. It was observed that the yogurt made from soymilk was softer than those made from milk, and the yogurts made from soymilk tasted neither bitter like the yogurts made from milk, nor sour like the traditional yogurts made with lactic acid-producing bacteria. Moreover, the yogurts made from soymilk had a flavor of tofu pudding.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. a process for producing a yogurt, comprising:
(1) providing a protein liquid selected from the group consisting of milk, reconstituted milk and soymilk;
(2) adding to the protein liquid a Bacillus subtilis var: natto strain in the number of ranging from 8.33×10⁵ CFU to 2×10⁹ CFU per ml of the protein liquid;
(3) incubating the protein liquid added with the Bacillus subtilis var: natto strain as obtained in step (2) at a temperature between 25° C. and 60° C. for 2 hours to 24 hours; and
(4) acquiring the yogurt.

2. The process according to claim 1, wherein the protein liquid with the Bacillus subtilis var: natto strain is cultured at a temperature between 25° C. and 37° C.

3. The process according to claim 2, wherein the time for incubating the protein liquid with the Bacillus subtilis var: natto strain is 2 to 20 hours.

4. The process according to claim 1, wherein the protein liquid is milk.

5. The process according to claim 4, wherein the milk is low fat milk.

6. The process according to claim 5, wherein the number of Bacillus subtilis var: natto strain ranges from 8.33×10⁵ CFU/ml to 6.67×10⁶ CFU/ml.

7. The process according to claim 6, wherein the number of Bacillus subtilis var: natto strain is 6.67×10⁶ CFU/ml.

8. The process according to claim 4, wherein the low fat milk with the Bacillus subtilis var: natto strain is incubated at a temperature between 25° C. and 60° C. for 2 hours to 8 hours.

9. The process according to claim 8, wherein the low fat milk with Bacillus subtilis var: natto strain is incubated at a temperature between 25° C. and 37° C. for 6 hours to 8 hours.

10. The process according to claim 9, wherein the low fat milk with Bacillus subtilis var: natto strain is incubated at 25° C. for 8 hours.

11. The process according to claim 1, wherein the protein liquid is reconstituted milk.

12. The process according to claim 11, wherein the reconstituted milk is reconstituted low fat milk.

13. The process according to claim 11, wherein the number of Bacillus subtilis var: natto strain ranges from 8.33×10⁵ CFU/ml to 6.67×10⁶ CFU/ml.

14. The process according to claim 13, wherein the number of Bacillus subtilis var: natto strain is 6.67×10⁶ CFU/ml.

15. The process according to claim 11, wherein the reconstituted low fat milk with Bacillus subtilis is incubated at a temperature between 25° C. and 37° C. for 2 hours to 24 hours.

16. The process according to claim 15, wherein the reconstituted low fat milk with Bacillus subtilis var. natto strain is incubated at 25° C. to 37° C. for 3 hr.

17. The process according to claim 1, wherein the protein liquid is soymilk.

18. The process according to claim 17, wherein the soymilk is sugarless soymilk.

19. The process according to claim 18, wherein the number of Bacillus subtilis var. natto strain ranges from 5×10⁸ CFU/ml to 2×10⁹ CFU/ml.

20. The process according to claim 18, wherein the soymilk with Bacillus subtilis var. natto strain is incubated at 37° C. for 7 hours to 9 hours.

21. The process according to claim 1, wherein the Bacillus subtilis var. natto strain is in a form of dry power.

22. The process according to claim 21, wherein the dry powder of the Bacillus subtilis var. natto strain contains at least 1×10⁹ CFU/g of the bacteria.

23. A yogurt made by the process according to claim 1.
